(19) United States
(12) Patent Application Publication
(10) Pub. No.: US 2024/0400298 A1
(43) Pub. Date: Dec. 5, 2024

(54) DEBRIS COLLECTOR ASSEMBLY

(71) Applicant: Techtronic Cordless GP, Anderson, SC (US)

(72) Inventors: Johnathon Lewchuk, Charlotte, NC (US); Kirti Kant Paulla, Indian Land, SC (US)

(21) Appl. No.: 18/672,188

(22) Filed: May 23, 2024

Related U.S. Application Data
(60) Provisional application No. 63/505,289, filed on May 31, 2023.

(51) Int. Cl. B65F 1/10; A47L 9/12; A47L 9/14; A47L 9/16; A47L 9/28; B65F 1/06; B65F 1/08; B65F 1/16

(52) U.S. Cl. CPC B65F 1/105; A47L 9/12; A47L 9/1418; A47L 9/1472; A47L 9/1666; A47L 9/281; A47L 9/2842; B65F 1/06; B65F 1/08; B65F 1/163; B65F 1/1646; B65F 2210/168; B65F 2210/179

(57) ABSTRACT

A debris collector assembly including a bottom side placed on a surface and a debris inlet adjacent the bottom side and configured to receive surface debris drawn from the surface. A debris container is in a body housing and the debris container includes an open top end. A suction source is operable to generate a suction airflow along an airflow path extending from the debris inlet to an exhaust outlet. The suction airflow is operable to draw the surface debris through the debris inlet with the suction airflow. The assembly also includes a lid, the lid movable between an open position and a closed position. In the open position, the open top end of the debris container is accessible by a user to deposit items into the debris container, and in the closed position, access to the open top end of the debris container is inhibited.

### CROSS-REFERENCE TO RELATED APPLICATIONS

This application claims priority to U.S. Provisional Patent Application No. 63/505,289, filed May 31, 2023, the entire contents of which are hereby incorporated by reference herein.

### BACKGROUND

The present disclosure relates to debris collectors.

### SUMMARY

In one embodiment, the disclosure provides a debris collector assembly including a body housing including a bottom side configured to be placed on a surface and a debris inlet adjacent the bottom side of the body housing and configured to receive debris drawn from the surface. A debris container is in the body housing and the debris container includes an open top end having a perimeter and the debris container includes a wall forming a container volume. A suction source is operable to generate a suction airflow along an airflow path extending from the debris inlet to an exhaust outlet, the suction airflow operable to draw the surface debris through the debris inlet with the suction airflow. The debris collector assembly further includes an upper housing forming a plenum over the open top end of the debris container. The upper housing includes an inside wall extending upwardly around at least a portion of the perimeter of the open top end of the debris container. The upper housing also includes a lid, the lid movable between an open position and a closed position. In the open position, the open top end of the debris container is accessible by a user to deposit items into the debris container, and in the closed position, access to the open top end of the debris container is inhibited. An inlet duct extends from the debris inlet to a debris outlet. The debris outlet is disposed in the upper housing inside wall in fluid communication with the debris inlet along the inlet duct and in fluid communication with the debris container. The debris outlet is configured to deposit the surface debris drawn from the surface through the debris inlet into the debris container. An upper housing outlet is along the airflow path downstream of the debris outlet disposed in the upper housing inner wall, through which the suction airflow travels after debris is deposited into the debris container. A separator is disposed in an outlet passageway along the airflow path downstream of the upper housing outlet and upstream of the suction source. The debris outlet is adjacent the upper housing outlet along the upper housing inner wall.

Other aspects of the disclosure will become apparent by consideration of the detailed description and accompanying drawings.

### BRIEF DESCRIPTION OF THE DRAWINGS

FIG. 1 is a perspective view of a debris collector assembly according to an embodiment of the disclosure.

FIG. 2 is a perspective view of the debris collector assembly of FIG. 1 with a lid in an open position.

FIG. 3 is an alternative perspective view of the debris collector assembly of FIG. 1.

FIG. 4 is an exploded view of the debris collector assembly of FIG. 1.

FIG. 5 is a cross-sectional view of the debris collector assembly of FIG. 1 with a debris container removed.

FIG. 6A is the cross-sectional view of FIG. 5 but with the debris container installed in the debris collector assembly.

FIG. 6B is the cross-sectional view of FIG. 6A but with a bag installed in the debris container.

FIG. 7 is a perspective view of the debris collector assembly of FIG. 1 with an upper housing removed.

FIG. 8 is a perspective view of a debris collector assembly according to another embodiment of the disclosure.

FIG. 9 is a perspective view of the debris collector assembly of FIG. 8 with a body housing removed.

FIG. 10 is an alternative perspective view of the debris collector assembly of FIG. 8 with the body housing removed.

FIG. 11 is an alternative perspective view of the debris collector assembly of FIG. 8 with the body housing and a debris container removed.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

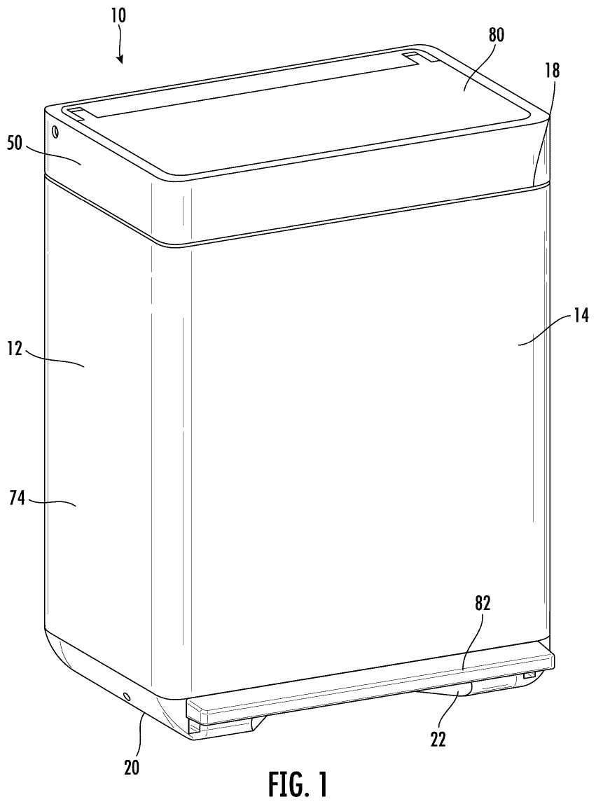

FIG. 1 illustrates a debris collector assembly 10 that is operable to draw debris from a surface (e.g., floor) and store the debris inside the assembly 10. Also, the debris collector assembly 10 is openable to deposit debris into the debris collector assembly 10, for example trash or debris from a dustpan, a vacuum cleaner debris collector, or the like. In one embodiment, the debris collector assembly 10 is powered by alternating current (AC power) from an outlet. In other embodiments, the debris collector assembly 10 is battery powered. In such battery powered embodiments, the debris collector assembly 10 may be operable to recharge the battery from the outlet and the battery is removable for use with a vacuum cleaner. In yet other embodiments, the debris collector assembly 10 can be powered by both a battery and AC power from an outlet.

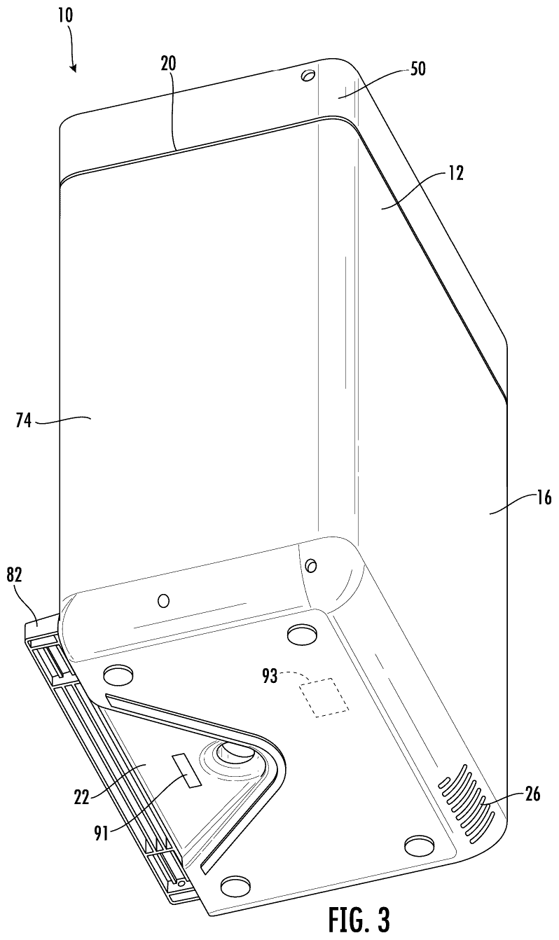

Referring to FIGS. 1 and 3, the debris collector assembly 10 includes a body housing 12 having a front side 14, a back side 16 opposite the front side 14, a top side 18, and a bottom side 20 opposite the top side 18. The bottom side 20 is placed on the surface (e.g., floor). A debris inlet 22 is adjacent the bottom side 20. In the illustrated embodiment, the debris inlet 22 is partially located in the front side 14 and the bottom side 20. The debris inlet 22 receives surface debris drawn from the surface by the debris collector assembly 10, which will be discussed in more detail below.

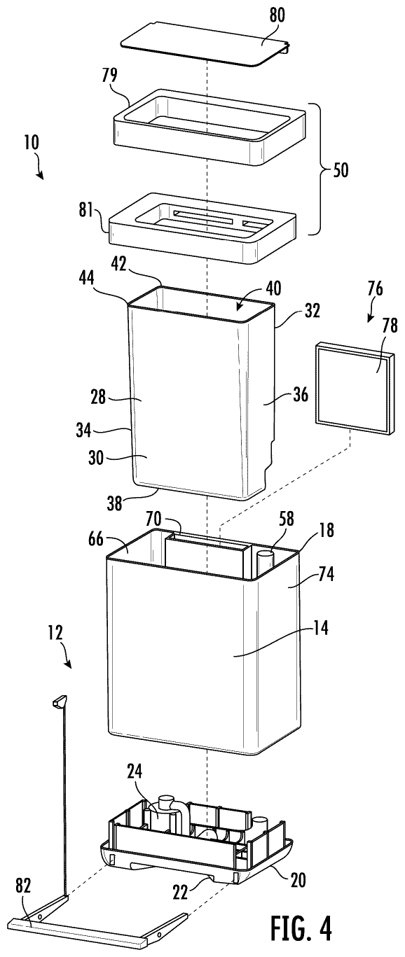

Referring to FIGS. 3 and 4, the debris collector assembly 10 further includes a suction source 24 that is operable to generate a suction airflow along an airflow path extending from the debris inlet 22 to an exhaust outlet 26. The suction source 24 is operable to draw the surface debris through the debris inlet 22 with the suction airflow. In one embodiment, suction source 24 includes a motor and a fan.

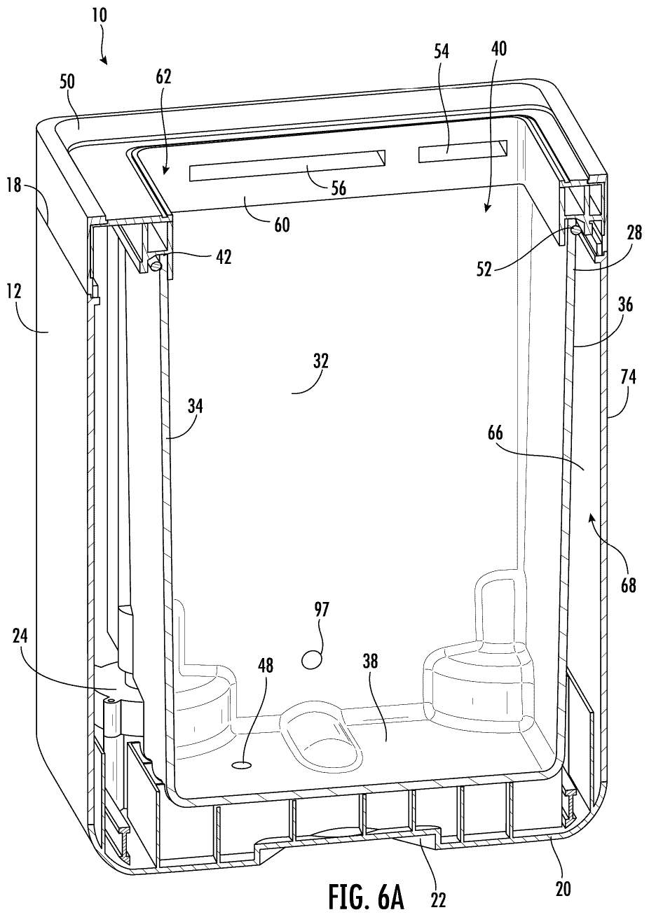

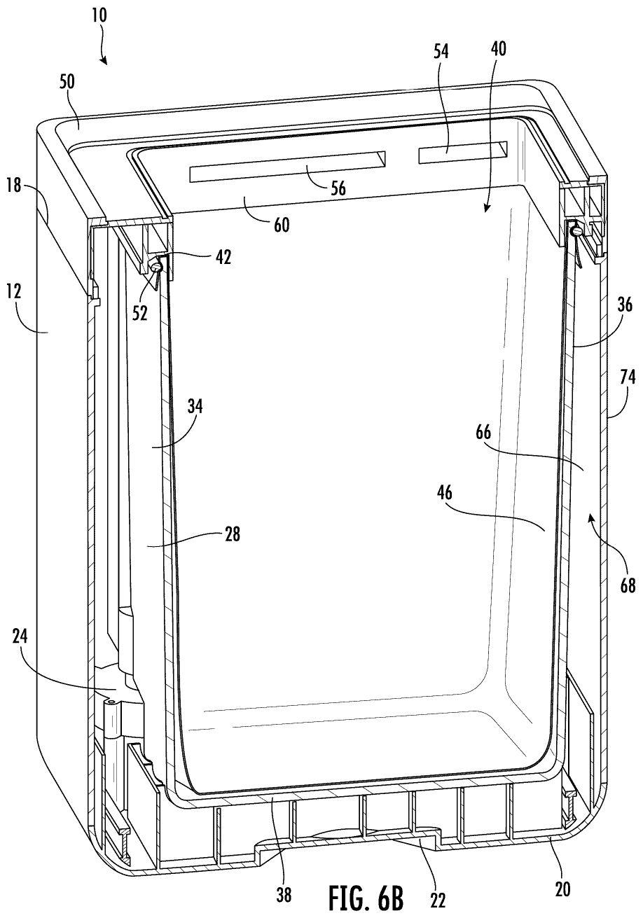

Referring to FIGS. 4, 6A, and 6B, the debris collector assembly 10 further includes a debris container 28 that is in the body housing 12. In one embodiment, the debris container 28 is removable from the body housing 12, for example, for emptying the debris container 28 without having to move the entire debris collector assembly 10. The illustrated debris container 28 includes a front wall 30, a rear wall 32 opposite the front wall 30, a first side wall 34 that extends from the front wall 30 to the rear wall 32, and a second side wall 36 that extends from the front wall 30 to the rear wall 32, opposite the first side wall 34. The front wall 30 is offset from the front side 14 of the body housing 12 adjacent the debris inlet 22. A bottom wall 38 extends between the walls 30, 32, 34, 36. Together the walls 30, 32, 34, 36, 38 form a container volume 40. In the illustrated embodiment, the debris container includes multiple walls, 30, 32, 34, 36, 38, but in other embodiments, the debris container may have other shapes with fewer walls than the illustrated embodiment (e.g., cylindrical) or more walls than the illustrated embodiment.

The debris container 28 includes an open top end 42 having a perimeter 44. The debris container 28 may receive a removable bag 46 through the open top end 42 as shown in FIG. 6B. The bag 46 may include a trash or garbage bag made from plastic, such as low-density polyethylene. An aperture 48 (FIG. 6A) extends through the bottom wall 38 of the debris container 28 adjacent the bag 46. The aperture 48 is in fluid communication with the suction source 24. A duct 49 connects the aperture 48 with the suction source 24. The duct 49 includes an inlet 51. The inlet 51 is adjacent the aperture 48 and in fluid communication with the aperture 48 when the debris container 28 is in the body housing 12. The suction source 24 is operable to generate an auxiliary airflow through the aperture 48 and the duct 49 to draw the bag 46 toward the walls 30, 32, 34, 36, 38 of the debris container 28. In one embodiment the auxiliary airflow is separate from the suction airflow through the debris inlet 22. For example, the auxiliary airflow and the suction airflow may have a parallel flow path arrangement. In the illustrated embodiment, the debris container 28 includes only a single aperture 48 in the bottom wall 38. In other embodiments, the debris container 28 may include multiple apertures 48 and/or apertures located in the walls 30, 32, 34, 36.

The debris collector assembly 10 further includes an upper housing 50. In the illustrated embodiment, the upper housing 50 is removably coupled to the debris container 28 and the body housing 12 and the upper housing 50 is removable from the body housing 12 with the debris container 28. As shown in FIG. 6B, the bag 46 is captured between the upper housing 50 and the debris container 28 to removably couple the bag 46 to the debris container 28. The bag 46 is wrapped around the perimeter 44 of the open top end 42 of the debris container 28 and the upper housing 50 is set on the open top end 42 as shown in FIG. 6B. The upper housing 50 includes a seal 52 that presses against the bag 46 to couple the bag 42 to the debris container 28 inhibiting airflow into the volume 40 between the bag 42 and the upper housing 50.

Referring to FIG. 6A, the upper housing 50 further includes a debris outlet 54 and an upper housing outlet 56 that are located adjacent the rear wall 32 of the debris container 28. In the illustrated embodiment, the debris outlet 54 is adjacent the upper housing outlet 56, as shown. Also, in the illustrated embodiment, both the debris outlet 54 and the upper housing outlet 56 are disposed in an inner wall 60 of the upper housing 50. The inner wall 60 extends upwardly around the perimeter 44 of the open top end 42 of the debris container 28. Therefore, the upper housing 60 forms a plenum 62 over the open top end 42 of the debris container 28. In the illustrated embodiment, the debris outlet 54 and the upper housing outlet 56 are adjacent the rear wall 32, but in other embodiments, the outlets 54, 56, may be in other suitable locations. For example, the debris outlet 54 may be located adjacent the first side wall 34 and the upper housing outlet 56 may be located adjacent the opposite second side wall 36, or the outlets 54, 56 could be located on the same side wall 34 or 36. In other embodiments, one or both of the outlets 54, 56 could be adjacent the front wall 28. Also, the illustrated outlets 54, 56 are rectangular but can have other shapes in other embodiments.

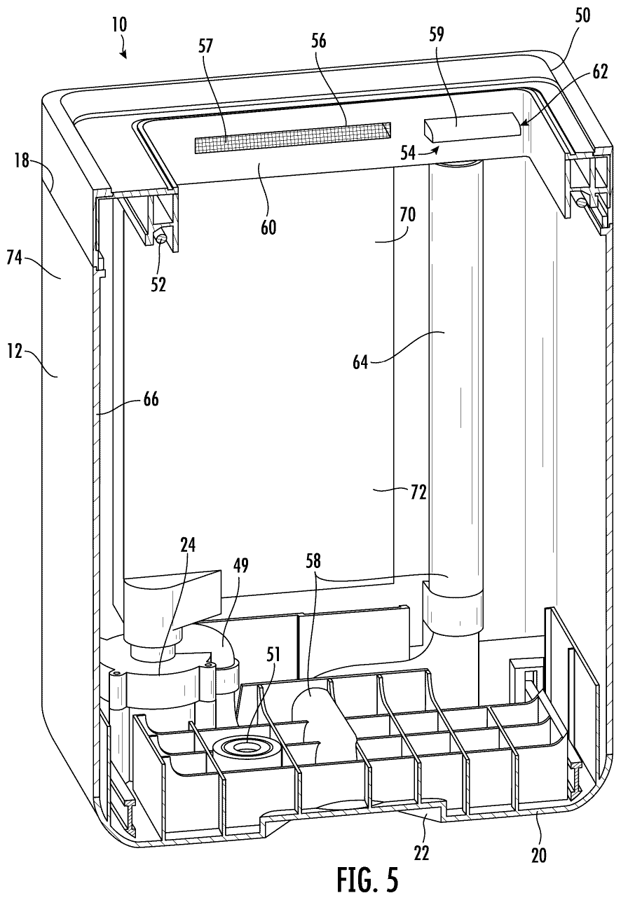

Referring to FIGS. 5, 6A, and 6B, the debris outlet 54 is in fluid communication with the debris inlet 22 along an inlet duct 58. The debris outlet 54 is configured to deposit the surface debris drawn from the surface through the debris inlet 22 into the debris container 28 and the bag 46. In some embodiments, a shroud is located above the debris outlet 54. The shroud directs the surface debris in a downward direction into the debris container 28 and the bag 46. The upper housing outlet 56 is located along the airflow path downstream of the debris outlet 54. After debris is deposited into the debris container 28 and the bag 46, the suction airflow travels through the upper housing outlet 56 and toward the suction source 24. In some embodiments, a screen 57 (FIG. 5) is located over the upper housing outlet 56 to inhibit debris from traveling through the upper housing outlet 56. In one embodiment, a deflector 59 (FIG. 5) is provided adjacent the debris outlet to direct debris downwardly toward the debris container.

The inlet duct 58 extends from the debris inlet 22 to the debris outlet 54. The illustrated inlet duct 58 includes a vertical portion 64 that is located between the rear wall 32 of the debris container 28 and the body housing 12. The vertical portion 64 is rearward of the debris container 28 and between the debris container 28 and the back side 16 of the body housing 12. The body housing 12 includes an inner wall 66 that defines a cavity 68 that receives the debris container 28. The inlet duct 58 is positioned exterior to the inner wall 66 of the body housing 12. Thus, the inlet duct 58 is positioned between the debris container 28 and the inner wall 66 of the body housing 12 in the cavity 68.

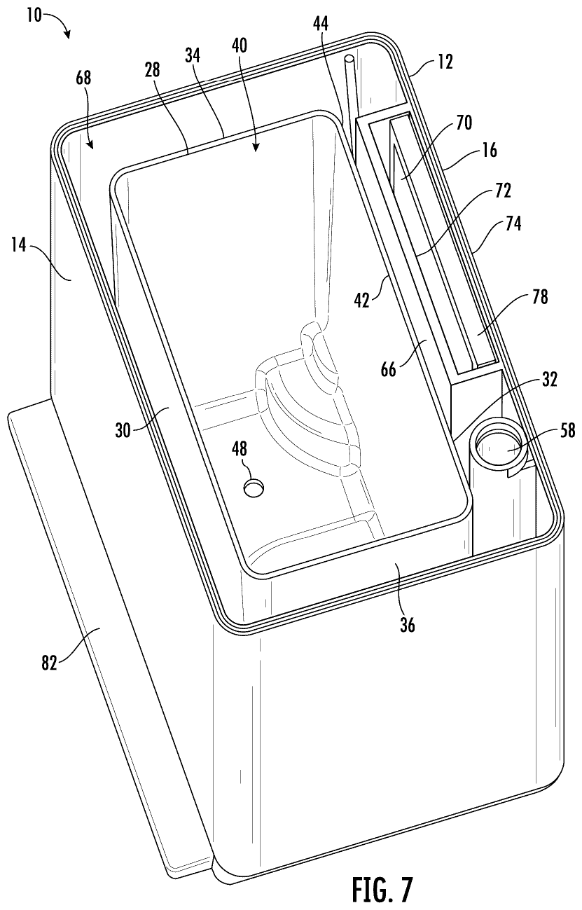

An outlet passageway 70 extends from the upper housing outlet 56 to the suction source 24. In the illustrated embodiment, the outlet passageway 70 is adjacent the inlet duct 58, which are both adjacent the back side 16 of the body housing 12. A vertical portion 72 of the outlet passageway 70 is rearward of the debris container 28 and between the debris container 28 and the back side 16 of the body housing 12. The body housing 12 includes the inner wall 66 and an outer wall 74. Referring to FIG. 7, the vertical portion 72 of the outlet passageway 70 is positioned between the inner wall 66 and the outer wall 74 such that the vertical portion 72 is integrally formed with the body housing 12 has a single component in the illustrated embodiment.

Referring to FIGS. 4, 5, and 6B, a separator 76 is disposed in the outlet passageway 70 along the airflow path downstream of the upper housing outlet 56 and upstream of the suction source 24. In the illustrated embodiment, the separator 76 includes a filter 78. The filter 78 can include any suitable type of filter, including a pleated filter, a fiberglass filter, an electrostatic filter, and the like. In the illustrated embodiment, the filter 78 is a panel style filter. In other embodiments, the separator 76 can include other types of separators including a cyclonic separator, multi-stage cyclonic separator, filter bags, other types of filters and any combination thereof.

The illustrated filter 78 is rearward of the debris container 28 and between the debris container 28 and the back side 16 of the body housing 12. Also, the filter 78 is in the vertical portion 72 of the outlet passageway 70 that is between the inner wall 66 and the outer wall 74 of the body housing 12. The filter 78 divides the vertical portion 72 into an upstream portion and a downstream portion, wherein the filter is installed into the vertical portion 72 such that the airflow through the outlet passageway 70 passes through the filter 78. In the illustrated embodiment, the filter 78 is set into the vertical portion 72 at an angle. The filter 78 is removable and replaceable by removing the upper housing 50 from the body housing 12. With the upper housing 50 removed, the filter 78 can be removed from the outlet passageway 70 and replaced with a new filter 78. In other embodiments, the upper housing 50 may include a door that allows the user to replace the filter 78 without removing the upper housing 50 from the body housing 12.

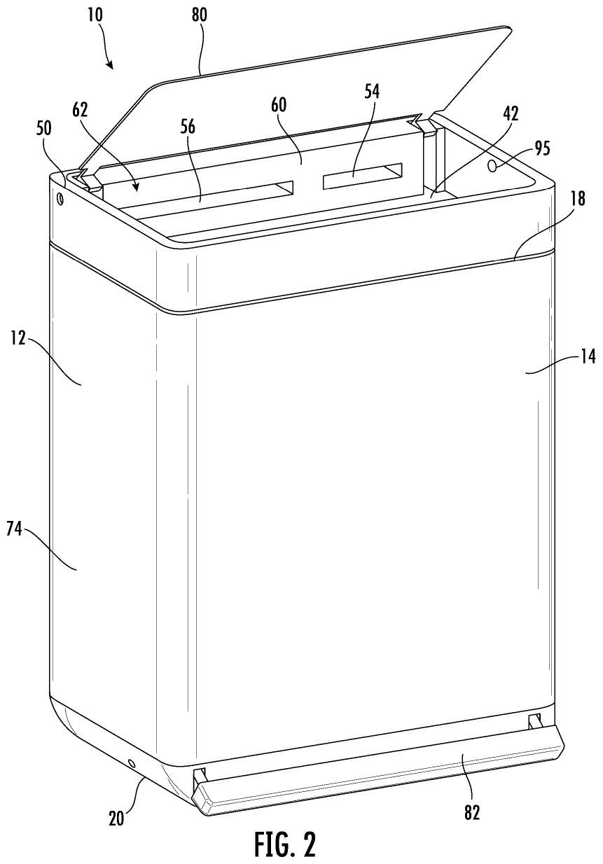

In the illustrated embodiment, the upper housing 50 includes a decorative trim ring 79 surrounding an upper housing body 81 (FIG. 4). In some embodiments, the decorative trim ring 79 is omitted and the upper housing body 81 forms the upper housing 50 and the outer surface of the debris collector assembly 10. The upper housing 50 further includes a lid 80. The lid 80 is movable between an open position (FIG. 2) and a closed position (FIG. 1). In the illustrated embodiment, the lid 80 is pivotally coupled to the trim ring 79 of the upper housing 50 such that the lid 80 pivots between the opened and closed positions. In some embodiments, the lid 80 is pivotably coupled to the upper housing body 81. Also, the lid 80 moves upwardly toward the back side 16 of the body housing 12 when the lid 80 moves from the closed position to the opened positions. This allows the user to access the debris container 28 from the front side 14 of the body housing 12. In the opened position, the open top end 42 of the debris container 28 is accessible by a user to deposit debris into the bag 46 and the debris container 28. In the closed position of the lid 80, access to the open top end 42 of the debris container 28 is inhibited. The illustrated debris collector assembly 10 includes a foot pedal 82 that moves the lid 80 from the closed position to the opened position. In some embodiments, when the lid 80 is in the opened position, the airpath between the debris inlet and the suction source 24 is opened and operation of the suction source 24 may be disabled. Also, when the lid is in the closed position, the airpath is operable and operation of the suction source 24 may be enabled (e.g., by an electronic or electromechanical switch, a button, toggle, or the like). In other embodiments, when the lid 80 is in the closed position, the airpath is operable and operation of the suction source 24 may be enabled based on recognition of the foot pedal 82 being pressed to open the lid 80 and then released to close the lid 80. In yet other embodiments, the suction source 24 may be enabled based on the recognition of the foot pedal being 82 pressed to open the lid 80.

In operation, a user may move debris, for example by sweeping, toward the debris inlet 22. The suction source 24 may be activated and the debris is drawn through the debris inlet 22 by the suction airflow. In some embodiments, a sensor 91 (FIG. 3) may be provided adjacent to or as part of the debris inlet 22 to detect the presence of debris. The sensor (e.g., a dirt sensor being infrared, acoustic, or the like) may provide a signal to activate the suction source 24 upon detection of debris at or near the debris inlet 22. The sensor 91 is in communication with a controller 93. The controller 93 may control operation of the suction source 24 based on the sensor 91 detecting the presence of debris. For example, if the sensor 91 senses debris, the sensor 91 signals the controller 93 to activate the suction source 24 to generate the suction airflow. In some embodiments, the controller 93 activates the suction source 24 for a predetermined period (e.g., 10 seconds, 20 seconds) after the sensor 91 senses the presence of debris. In some embodiments, a sensor 95 (FIG. 2) may be provided to determine whether the lid 80 is in the open position or in the closed position. The sensor 95 may include a contact switch, proximity sensor, or the like. The sensor 95 is also in communication with the controller 93. When the lid 80 is in the open position, the sensor 95 signals the controller 93 and the controller 93 may disable operation of the suction source 24 while the lid 80 is in the open position. In some embodiments, the controller 93 disables opening the lid 80 when the suction source 24 is activated and generating the suction airflow. For example, the controller 93 may disable operation of the foot pedal 82 or make the foot pedal 82 inoperable to open the lid 80 when the suction source 24 is generating a suction airflow. In some embodiments, a sensor 97 (FIG. 6A), for example, a pressure sensor or optical sensor, may be provided to determine whether a bag 46 is in the debris container 28. The sensor 97 is also in communication with the controller 93. When the there is no bag 46 in the debris container 28, the sensor 97 signals the controller 93 and the controller 93 may disable operation of the suction 24.

After the debris is drawn through the inlet 22, the debris travels through the inlet duct 58 and through the debris outlet 54. The debris is deposited in the debris container 28 and the bag 46. The suction airflow then travels through the plenum 62 and through the upper housing outlet 56. After passing through the upper housing outlet 56, the suction airflow travels through the separator 76, which include the filter 78, to remove additional particles from the suction airflow. The airflow then travels through the suction source 24 and is exhausted from the debris collector assembly through the exhaust outlet 26. The user may also open the lid 80, as discussed above, to deposit debris directly into the debris container 28 and the bag 46 through the open top end 42 of the debris container 28 without using the suction source 24.

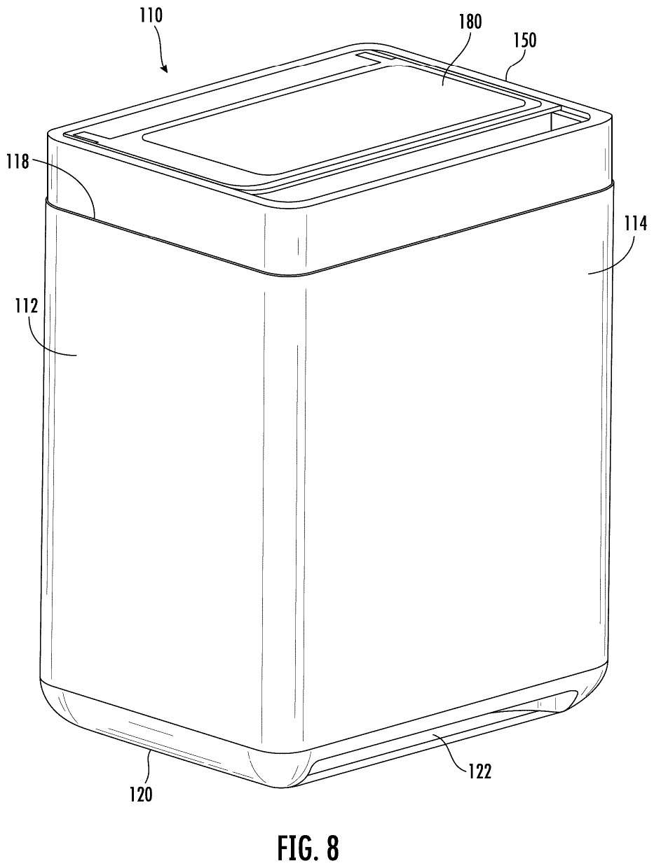

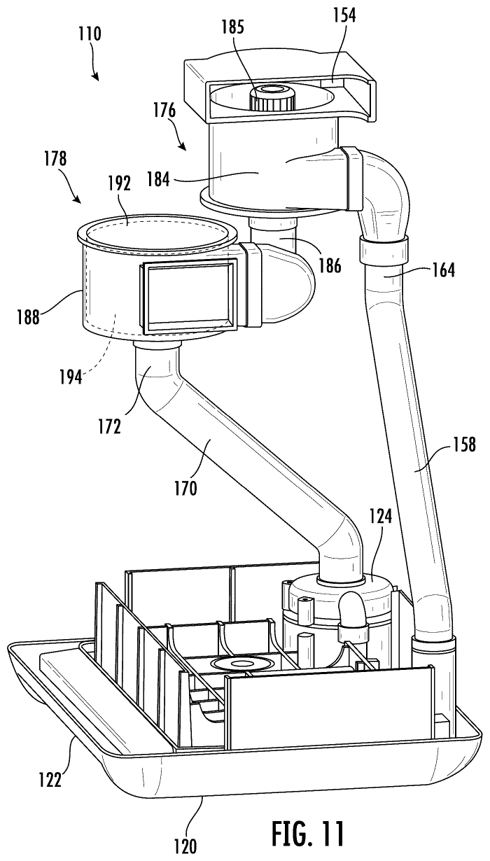

FIGS. 8-11 illustrates a debris collector assembly 110 according to another embodiment. The debris collector assembly 110 includes features of the debris collector 10 of FIGS. 1-7 and like components have been given the same reference number plus 100. Only differences between the debris collector assemblies 10, 110 will be discussed below.

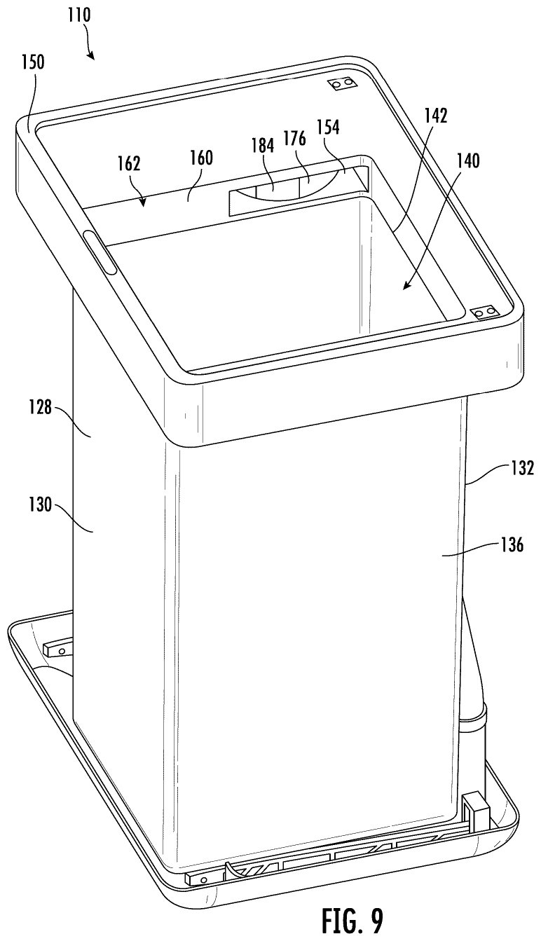

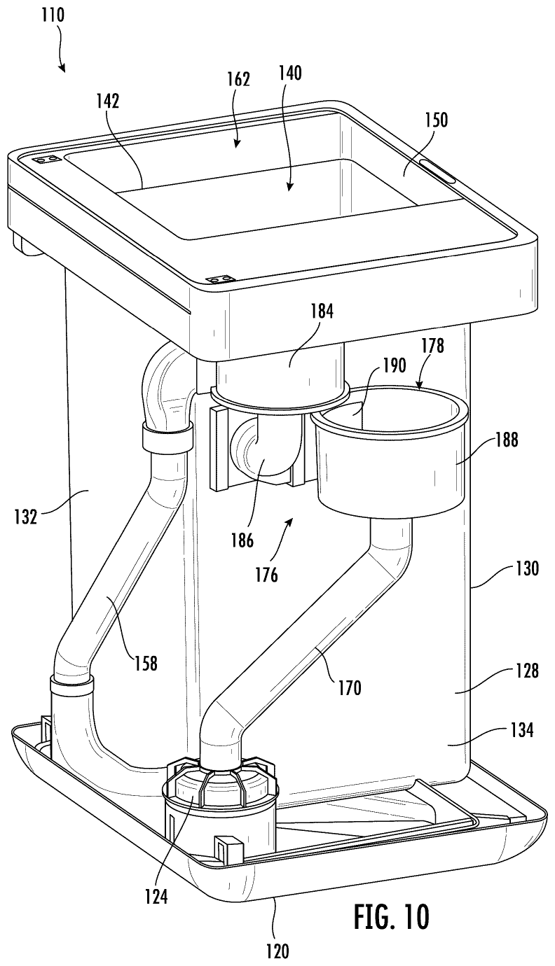

Referring to FIGS. 9 and 10, the debris collector assembly 110 includes a separator 176 that includes a cyclonic separator 184 and a filter 178. The inlet duct 158 directs the surface debris from the debris inlet 122 to the cyclonic separator 184. The illustrated cyclonic separator 184 is an over-the-wall type separator and debris is discharged from the separator through the debris outlet 154 and into the debris container 28, which may include a bag as discussed above. The suction airflow then exits the cyclonic separator 184 through an outlet shroud 185 and travels through a duct 186 that connects the cyclonic separator 184 with the filter 178. The filter 178 includes a filter chamber 188 with a tangential inlet 190, a filter chamber cover 192, and a filter 194 (the filter cover 192 and filter 194 omitted from FIG. 10 to show the tangential inlet 190). The filter 178 further filters the suction airflow to remove relatively fine debris. The suction airflow exits the filter 178 to the outlet passageway 170 and travels through the outlet passageway 170 to the suction source 124 and the airflow is exhausted from the debris collector assembly 110.

The present disclosure describes several embodiments. Features from one embodiment may be utilized and/or combined with features in any of the other embodiments even if not specifically discussed herein. Various features and advantages are set forth in the following claims.

What is claimed is:

1. A debris collector assembly comprising:
a body housing including a bottom side configured to be placed on a surface and a debris inlet adjacent the bottom side of the body housing and configured to receive surface debris drawn from the surface;
a debris container in the body housing, the debris container including an open top end having a perimeter and the debris container including a wall forming a container volume;
a suction source operable to generate a suction airflow along an airflow path extending from the debris inlet to an exhaust outlet, the suction airflow operable to draw the surface debris through the debris inlet with the suction airflow;
an upper housing forming a plenum over the open top end of the debris container, the upper housing including an inside wall extending upwardly around at least a portion of the perimeter of the open top end of the debris container, the upper housing including a lid, the lid movable between an open position and a closed position, wherein in the open position, the open top end of the debris container is accessible by a user to deposit items into the debris container, and in the closed position, access to the open top end of the debris container is inhibited;
an inlet duct extending from the debris inlet to a debris outlet, the debris outlet disposed in the upper housing inside wall in fluid communication with the debris inlet along the inlet duct and in fluid communication with the debris container, the debris outlet configured to deposit the surface debris drawn from the surface through the debris inlet into the debris container;
an upper housing outlet along the airflow path downstream of the debris outlet disposed in the upper housing inner wall, through which the suction airflow travels after debris is deposited into the debris container;
a separator disposed in an outlet passageway along the airflow path downstream of the upper housing outlet and upstream of the suction source;
wherein the debris outlet is adjacent the upper housing outlet along the upper housing inner wall.

2. The debris collector assembly of claim 1, wherein the debris container is configured to receive a bag through the open top end, the debris collector assembly further comprising an aperture in the wall of the debris container, the aperture in fluid communication with the suction source, the aperture adjacent the bag, wherein the suction source is operable to generate an auxiliary airflow through the aperture to draw the bag toward the debris container.

3. The debris collector assembly of claim 2, wherein in the open position of the lid, the open top end of the debris container is accessible by a user to deposit debris into the bag and in the closed position of the lid, access to the open top end of the debris container and to the bag is inhibited.

4. The debris collector assembly of claim 1, wherein the debris container is removable from the body housing.

5. The debris collector assembly of claim 1, wherein the upper housing is removable from the body housing with the debris container.

6. The debris collector assembly of claim 2, wherein the bag is captured between the upper housing and the debris container to removably couple the bag to the debris container.

7. The debris collector assembly of claim 1, further comprising a foot pedal operable to move the lid from the closed position to the open position.

8. The debris collector assembly of claim 1, wherein the separator includes a cyclonic separator in fluid communication with the suction source, the debris inlet, and the debris outlet, the cyclonic separator positioned to receive debris from the debris inlet via the suction airflow and operable to separate debris from the suction airflow, the cyclonic separator in fluid communication with the debris outlet and operable to discharge the debris separated from the suction airflow into the debris container through the debris outlet.

9. The debris collector assembly of claim 1, further comprising a filter that receives the suction airflow from the cyclonic separator before the suction airflow travels through the suction source.

10. The debris collector assembly of claim 1, wherein the separator includes a filter.

11. The debris collector assembly of claim 1, wherein the body housing includes an inner wall defining a cavity that receives the debris container, wherein the inlet duct is positioned exterior to the inner wall of the body housing.

12. The debris collector assembly of claim 11, wherein the inlet duct is positioned between the debris container and the inner wall of the body housing in the cavity.

13. The debris collector assembly of claim 1, wherein the body housing includes an outer wall and an inner wall defining a cavity that receives the debris container, wherein the outlet passageway is positioned between the inner wall of the body housing and the outer wall of the body housing.

14. The debris collector assembly of claim 13, wherein the separator includes a filter located in the outlet passageway.

15. The debris collector assembly of claim 1, wherein the debris container includes a front wall and a rear wall opposite the front wall, wherein the debris inlet of the body housing is adjacent the front wall of the debris container, and wherein the debris outlet is adjacent the rear wall of the debris container.

16. The debris collector assembly of claim 1, wherein the body housing has a front side and a back side opposite the front side, wherein the lid moves toward the back side when the lid moves from the closed position to the open position, wherein the separator is rearward of the debris container, between the debris container and the back side of the body housing.

17. The debris collector assembly of claim 1, wherein the inlet duct is adjacent the outlet passageway.

18. The debris collector assembly of claim 1, wherein the body housing has a front side and a back side opposite the front side, wherein at least a portion of the inlet duct is rearward of the debris container, between the debris container and the back side of the body housing, and wherein at least a portion of the outlet passageway is rearward of the debris container, between the debris container and the back side of the body housing.

19. The debris collector assembly of claim 1, further comprising a screen over the upper housing outlet.

20. The debris collector assembly of claim 1, further including a shroud above the debris outlet configured to direct the surface debris in a downward direction into the debris container.

21. The debris collector assembly of claim 1, further comprising an aperture in the wall of the debris container, the aperture in fluid communication with the suction source.

22. The debris collector assembly of claim 1, further comprising:
a sensor operable to determine when the lid is in the open position;
a controller operable to control operation of the suction source, the controller in communication with the sensor to receive a signal from the sensor when the lid is in the open position, and the controller operable to disable operation of the suction source when the lid is in the open position.

23. The debris collector assembly of claim 1, further comprising a sensor operable to determine the presence of debris adjacent the debris inlet, the sensor in communication with a controller and the controller operable to enable operation of the suction source in response to debris adjacent the debris inlet.

24. The debris collector assembly of claim 23, wherein the controller enables operation of the suction source for a predetermined period of time in response to the second sensor determining the presences of debris adjacent the debris inlet.

25. The debris collector assembly of claim 24, wherein the predetermined period of time is in a range from 10 second to 20 seconds.
